(19) United States
(12) Patent Application Publication
(10) Pub. No.: US 2026/0154100 A1
(43) Pub. Date: Jun. 4, 2026

(54) MEMORY POOL CHARACTERISTICS PROVISIONING SYSTEM

(71) Applicant: Dell Products L.P., Round Rock, TX (US)

(72) Inventors: Krishnaprasad Koladi, Bangalore (IN); Vinod Parackal Saby, Bangalore (IN); Rama Rao Bisa, Bangalore (IN)

(21) Appl. No.: 18/967,869

(22) Filed: Dec. 4, 2024

(51) Int. Cl. G06F 9/455; G06F 11/34

(52) U.S. Cl. CPC G06F 9/45558; G06F 11/3409; G06F 2009/45583

(57) ABSTRACT

A memory pool characteristic provisioning system includes a computing device. A BIOS in the computing device identifies performance characteristics for memory devices coupled to the BIOS, and creates a Memory Device Performance Characteristics (MDPC) table including those performance characteristics. A hypervisor subsystem in the computing device provides a virtual machine with an operating system that is allocated a memory pool provided by a first subset of the memory devices, and uses the MDPC table to create a virtual MDPC (vMDPC) table for the operating system that identifies the performance characteristics for each of the first subset of the memory devices. The operating system then performs an operating system memory operation using one of the first subset of the memory devices that is selected based on its performance characteristics relative to the performance characteristics of the others of the first subset of the memory devices as identified in the vMDPC table.

### BACKGROUND

The present disclosure relates generally to information handling systems, and more particularly to providing memory pool characteristics to an operating system running on an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, are sometimes used to provide virtual machines that include operating systems. Furthermore, in some situations, the memory utilized by such operating systems may be included in a memory pool that may be made up of one or more memory devices that are included in their computing device, as well as one or more memory devices that may be included in memory systems that are connected or coupled to their computing device, and the conventional provisioning of such memory pools for operating systems for use by those operating systems raises issues. For example, conventional provisioning of a memory pool for use by an operating system provided by a computing device operates to expose that memory pool to the operating system as a usable memory space without distinguishing between the varying memory devices that are utilized to provide that memory space.

As described below, the inventors of the present disclosure have recognized that the varying memory devices that may be utilized to provide a memory pool may have different performance characteristics (e.g., performance characteristics that are based on the design of the memory device; performance characteristics that are affected by external factors such as how those memory devices are coupled to the operating system, current networking conditions, etc.; and/or other memory-device-performance-characteristic-influencing factors that would be apparent to one of skill in the art in possession of the present disclosure), and the identification of any particular memory device for use in performing any particular operating system memory operation for any workload provided using the virtual machine may benefit from the knowledge of those performance characteristics. For example, a memory pool exposed to an operating system may be provided using High Bandwidth Memory (HBM) devices, different Double Data Rate (DDR) memory devices (e.g., DDR4 memory devices, DDR5 memory devices, etc.), different types of Compute eXpress Logic (CXL) memory devices, and/or other memory devices known in the art, and the use of one of those memory devices may optimize the performance of any particular operating system memory operation during the provisioning of any particular workload by a virtual machine (e.g., HBM memory devices may offer better read and write performance relative to DDR memory devices).

Accordingly, it would be desirable to provide the memory pool characteristic provisioning system described below that addresses the issues discussed above and allows operating systems to allocate memory device(s) in their memory pools for use in the performance of any particular operating system memory operation for any particular workload based on the performance characteristics of those memory device(s).

### SUMMARY

According to one embodiment, an Information Handling System (IHS) includes a Basic Input/Output System (BIOS) processing system; a BIOS memory system that is coupled to the BIOS processing system and that includes instructions that, when executed by the BIOS processing system, cause the BIOS processing system to provide a BIOS that is configured to: identify a plurality of performance characteristics for each of a plurality of memory devices that are coupled to the BIOS processing system; and create a Memory Device Performance Characteristics (MDPC) table that includes the plurality of performance characteristics identified for each of the plurality of memory devices; a hypervisor processing system; and a hypervisor memory system that is coupled to the hypervisor processing system and that includes instructions that, when executed by the hypervisor processing system, cause the hypervisor processing system to provide a hypervisor engine that is configured to: provide a first virtual machine including a first operating system that is allocated a first memory pool that is provided by a first subset of the plurality of memory devices; and create, using the MDPC table, a first virtual MDPC (vMDPC) table for the first operating system that identifies the plurality of performance characteristics for each of the first subset of the plurality of memory devices, wherein the first operating system is configured to: perform a first operating system memory operation using a first memory device included in the first subset of the plurality of memory devices that is selected based on first performance characteristics identified in the first vMDPC table for the first memory device relative to second performance characteristics identified in the first vMDPC table for at least one second memory device included in the first subset of the plurality of memory devices.

### BRIEF DESCRIPTION OF THE DRAWINGS

FIG. 1 is a schematic view illustrating an embodiment of an Information Handling System (IHS).

FIG. 2 is a schematic view illustrating an embodiment of a networked system that may provide the memory pool characteristic provisioning system of the present disclosure.

FIG. 3 is a flow chart illustrating an embodiment of a method for providing memory pool performance characteristics.

FIG. 4 is a schematic view illustrating an embodiment of the networked system of FIG. 2 operating during the method of FIG. 3.

FIG. 5 is a schematic view illustrating an embodiment of the networked system of FIG. 2 operating during the method of FIG. 3.

FIG. 6 is a schematic view illustrating an embodiment of the networked system of FIG. 2 operating during the method of FIG. 3.

FIG. 7 is a schematic view illustrating an embodiment of the networked system of FIG. 2 operating during the method of FIG. 3.

FIG. 8 is a schematic view illustrating an embodiment of the networked system of FIG. 2 operating during the method of FIG. 3.

FIG. 9 is a schematic view illustrating an embodiment of the networked system of FIG. 2 operating during the method of FIG. 3.

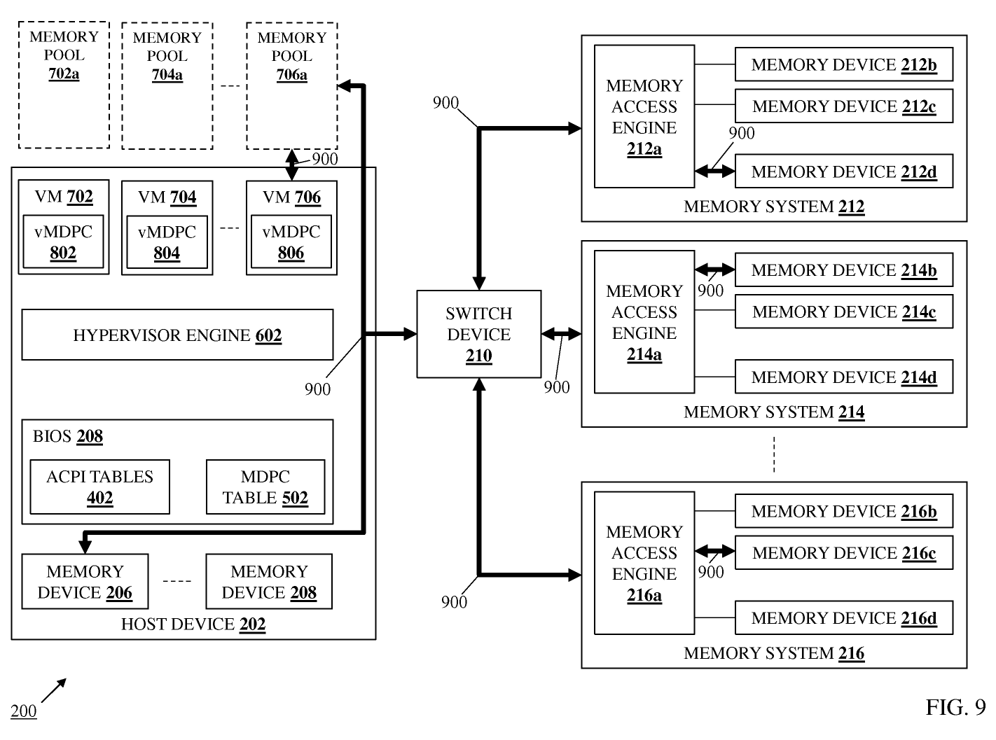

FIG. 10 is a schematic view illustrating an embodiment of the networked system of FIG. 2 operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

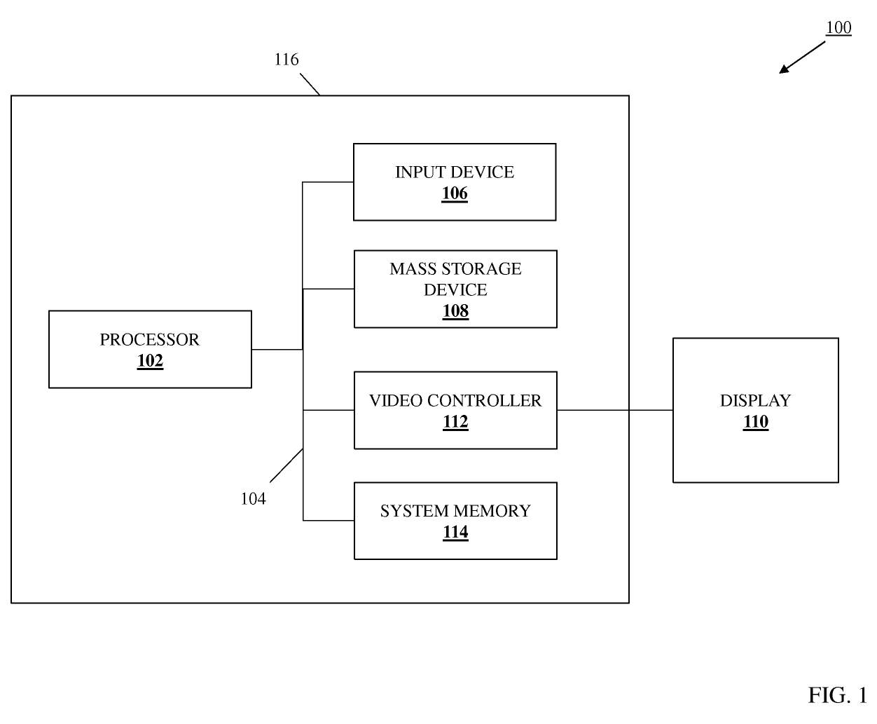

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

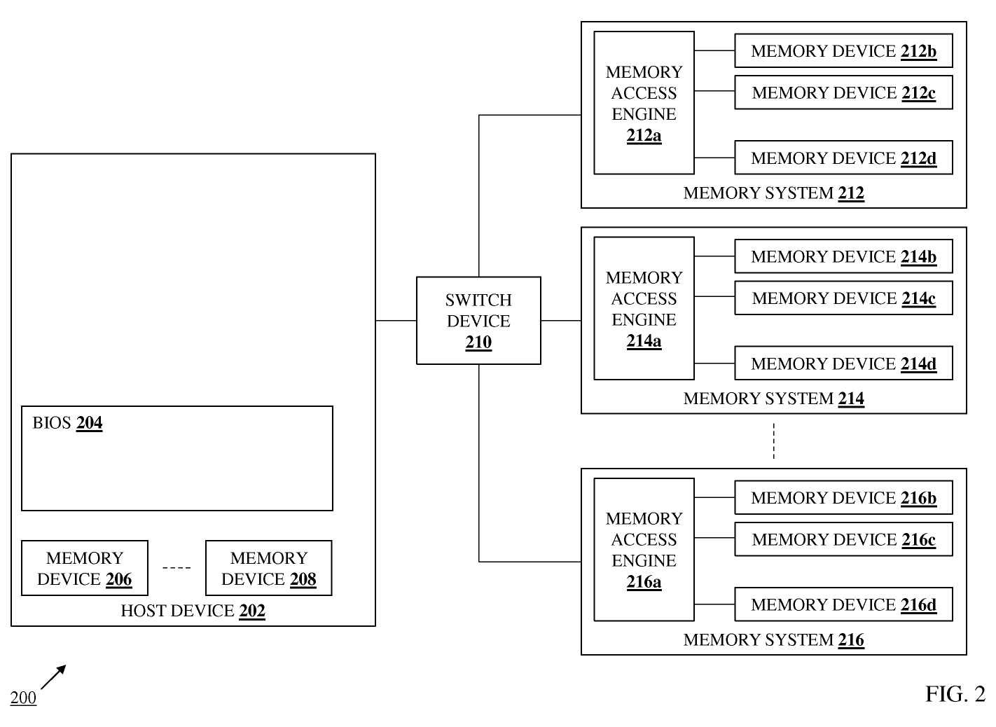

Referring now to FIG. 2, an embodiment of a networked system 200 is illustrated. In the illustrated embodiment, the networked system 200 includes a host device 202. In an embodiment, the host device 202 may be provided by the IHS 100 discussed above with reference to FIG. 1, and/or may include some or all of the components of the IHS 100, and in specific examples may be provided by a server device. However, while illustrated and discussed as being provided by a server device, one of skill in the art in possession of the present disclosure will recognize that the host device 202 may be provided by other computing devices while remaining within the scope of the present disclosure.

In the illustrated embodiment, the host device 200 may include a Basic Input/Output System (BIOS) processing system (not illustrated, but which may include any of a variety of BIOS processing firmware that would be apparent to one of skill in the art in possession of the present disclosure) and a BIOS memory system (not illustrated, but which may include any of a variety of BIOS memory firmware that would be apparent to one of skill in the art in possession of the present disclosure) that is coupled to the BIOS processing system and that includes instructions that, when executed by the BIOS processing system, cause the BIOS processing system to provide a BIOS 204 that is configured to perform the functionality of the BIOS discussed below, as well as hardware initialization during boot or other initialization of the host device 202, runtime services for an operating system and/or other applications provided by the host device 202, and/or any other BIOS functionality that would be apparent to one of skill in the art in possession of the present disclosure.

In the illustrated embodiment, the host device 202 may also include a plurality of memory devices 206 and up to 208, and as described below the memory devices 2062-08 may be provided by High Bandwidth Memory (HBM) devices, Double Data Rate (DDR) memory devices (e.g., DDR4 memory devices, DDR5 memory devices, etc.), and/or any other memory devices that would be apparent to one of skill in the art in possession of the present disclosure. However, while a specific host device 202 has been illustrated and described, one of skill in the art in possession of the present disclosure will recognize that host devices (or other devices operating according to the teachings of the present disclosure in a manner similar to that described below for the host device 202) may include a variety of components and/or component configurations for providing conventional host device functionality, as well as the memory pool performance characterization functionality discussed below, while remaining within the scope of the present disclosure as well.

As illustrated, the host device 202 may be coupled to a switch device 210. In the illustrated embodiment, the switch device 210 may be provided by the IHS 100 discussed above with reference to FIG. 1, and/or may include some or all of the components of the IHS 100, and in specific examples may be provided by a CXL Peripheral Component Interconnect express (PCIe) switch device that one of skill in the art in possession of the present disclosure will appreciate may be configured to provide the host device 202 access to the network-accessible memory devices described below while being optimized for CXL memory device sharing such that host device/memory device connections and memory resource sharing may be performed relatively quickly. However, while illustrated and discussed as being provided by a particular switch device, one of skill in the art in possession of the present disclosure will recognize that the switch device 210 may be provided by other networking device(s) while remaining within the scope of the present disclosure.

As illustrated, a plurality of memory systems 212, 214, and up to 216 may be coupled to the switch device 210. As will be appreciated by one of skill in the art in possession of the present disclosure, each of the memory systems may be provided in respective “host devices” that are configured to share those memory systems with the host device 202 as described below, may be provided by “stand-alone” memory systems that are available for use by the host device 202, and/or may be provided in a variety of other manner that one of skill in the art in possession of the present disclosure will appreciate will enable the functionality described below. Each of the memory systems 212-216 may include a processing system (not illustrated, but which may be similar to the processor 102 discussed above with reference to FIG. 1) and a memory system (not illustrated, but which may be similar to the memory 114 discussed above with reference to FIG. 1) that is coupled to the processing system and that includes instructions that, when executed by the processing system, cause the processing system to provide a memory access engine that is configured to perform the functionality of the memory access engines, memory access subsystems, and/or memory systems discussed below. As such, the memory system 212 may include a memory access engine 212a, the memory system 214 may include a memory access engine 214a, and the memory system 216 may include a memory access engine 216a.

Furthermore, each of the memory systems 212-216 may include a plurality of memory devices that are each coupled to the memory access engine (e.g., via a coupling between that memory device and the processing system that provides that memory access engine). As such, the memory system 212 may include a plurality of memory devices 212b, 212c, and up to 212d, each of which is coupled to the memory access engine 212a; the memory system 214 may include a plurality of memory devices 214b, 214c, and up to 214d, each of which is coupled to the memory access engine 214a; and the memory system 216 may include a plurality of memory devices 216b, 216c, and up to 216d, each of which is coupled to the memory access engine 216a.

In some embodiments, the memory devices 212b-212d, 214b-214d, and 216b-216d, may be provided by CXL memory devices that may include the HBM devices and/or DDR memory devices discussed above, as well as any other memory devices that would be apparent to one of skill in the art in possession of the present disclosure. In specific examples, the CXL memory devices may be “type 1” CXL memory devices, “type 2” CXL memory devices, or “type 3” CXL memory devices. As will be appreciated by one of skill in the art in possession of the present disclosure, “type 1” CXL memory devices may utilize the “CXL.io” protocol, which is used to handle device discovery, initialization, configuration, and Input/Output (IO) operations, while utilizing a non-coherent load/store interface that does not maintain cache coherency; and may also utilize the “CXL.cache” protocol to providing caching and cache coherency, while providing relatively low latency access to its memory (e.g., for use in high-performance computing tasks as described below).

As will also be appreciated by one of skill in the art in possession of the present disclosure, “type 2” CXL memory devices may utilize the “CXL.io” protocol and “CXL.cache” protocol discussed above, as well as the “CXL.mem” protocol that provides coherent access to its memory (both volatile memory (e.g., DRAM) and persistent non-volatile memory (e.g., flash memory)), while ensuring memory coherency (e.g., ensuring any changes made to its memory by the host device 202 and the CXL memory device are immediately visible to both).

As will also be appreciated by one of skill in the art in possession of the present disclosure, “type 3” CXL memory devices may utilize the “CXL.io” protocol and “CXL.mem” protocol discussed above to allow access and management of its memory (as well as memory expansion boards and persistent memory), while providing relatively low latency access to local DRAM or byte-addressable non-volatile storage. However, while specific memory systems 212-216 have been illustrated and described, one of skill in the art in possession of the present disclosure will recognize that memory systems used with the present disclosure may include a variety of components and/or component configurations for providing conventional network-accessible memory system functionality, as well as the memory pool performance characterization functionality discussed below, while remaining within the scope of the present disclosure as well.

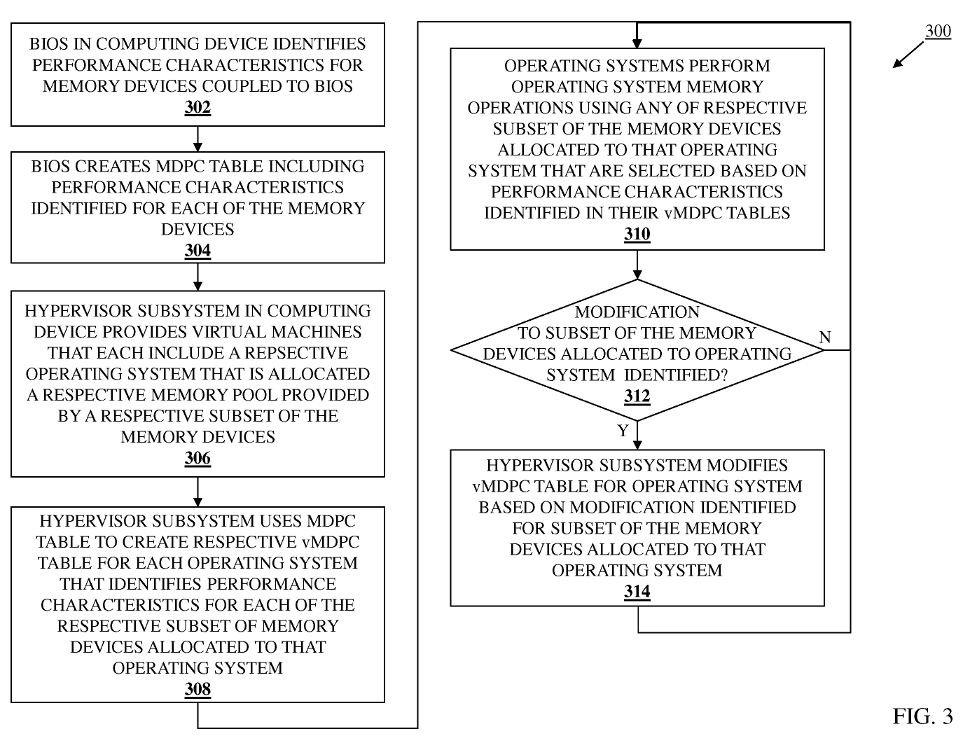

Referring now to FIG. 3, an embodiment of a method 300 for providing memory pool performance characteristics is illustrated. As discussed below, the systems and methods of the present disclosure create a Memory Device Performance Characteristics (MDPC) table that includes performance characteristics for memory devices that are accessible to a computing device, and then use the MDPC table to create a virtual MDPC (vMDPC) table for an operating system running on a virtual machine provided by that computing device, with the vMDPC table identifying the performance characteristics for a subset of the memory devices in a memory pool that are allocated to that operating system, and with the vMDPC table used by that operating system to select a particular one of that subset of memory devices to perform an operating system memory operation based on their relative performance characteristics.

For example, the memory pool characteristic provisioning system of the present disclosure may include a computing device. A BIOS in the computing device identifies performance characteristics for memory devices coupled to the BIOS, and creates a Memory Device Performance Characteristics (MDPC) table including those performance characteristics. A hypervisor subsystem in the computing device provides a virtual machine with an operating system that is allocated a memory pool provided by a first subset of the memory devices, and uses the MDPC table to create a virtual MDPC (vMDPC) table for the operating system that identifies the performance characteristics for each of the first subset of the memory devices. The operating system then performs an operating system memory operation using one of the first subset of the memory devices that is selected based on its performance characteristics relative to the performance characteristics of the others of the first subset of the memory devices as identified in the vMDPC table. As such, virtual machine operating systems may optimize their operating system memory operations by utilizing memory devices with the best performance characteristics for those operating system memory operations.

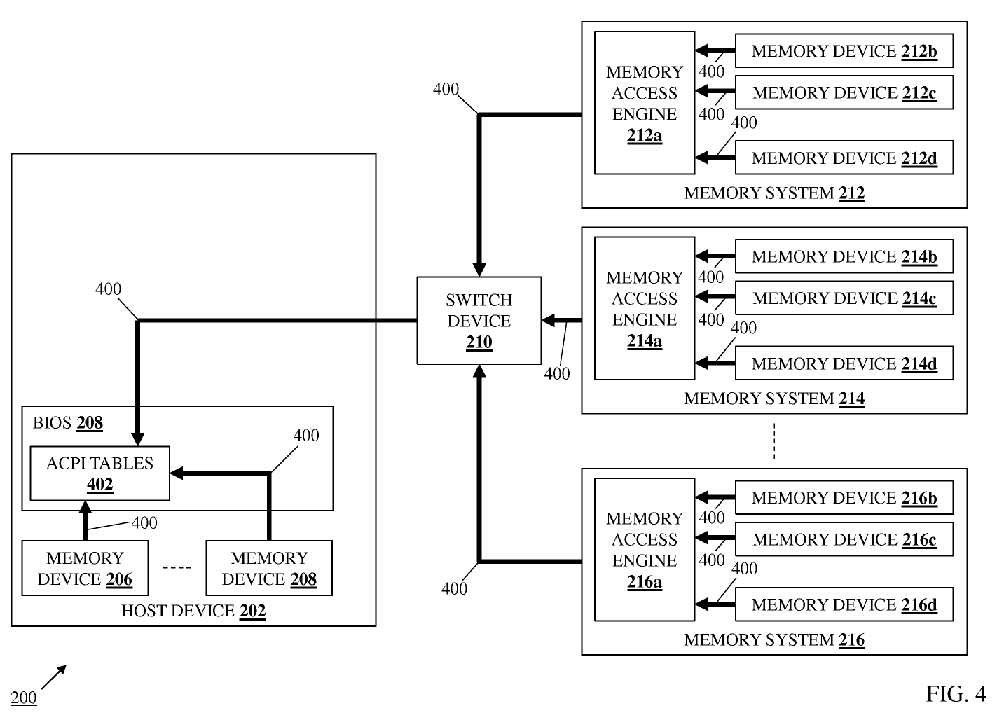

The method 300 begins at block 302 where a BIOS in a computing device identifies performance characteristics for memory devices coupled to the BIOS. In an embodiment, block 302, the host device 202 may be powered on, booted, reset, rebooted, and/or otherwise initialized, and one of skill in the art in possession of the present disclosure will recognize that the BIOS 208 in the host device 202 may perform a variety of initialization operations as part of its initialization of the host device 202. With reference to FIG. 4, in an embodiment of block 302 and as part of the initialization of the host device 202, the BIOS 208 may perform memory device performance characteristic identification operations 400 that include retrieving memory device information for each of the memory devices 206-208 in the host device 202, and retrieving memory device information for each of the memory devices 212b-212d in the memory system 212 (i.e., via the switch device 210 and the memory access engine 212a), the memory devices 214b-214d in the memory system 214 (i.e., via the switch device 210 and the memory access engine 214a), and the memory devices 216b-216d in the memory system 216 (i.e., via the switch device 210 and the memory access engine 216a), and then storing the performance characteristics for those memory devices in ACPI tables 402.

In some examples, the memory device information retrieved from the memory devices as part of the memory device performance characteristic identification operations 400 may provide performance characteristics for those memory devices, and thus the retrieval of any of that memory device information for a memory device will include the identification of performance characteristic(s) for that memory device. However, in other examples, the BIOS 208 may use any of a variety of performance characteristics identification techniques known in the art to extract, derive, and/or other identify the performance characteristics for a memory device using the memory device information retrieved from that memory device.

To provide a specific example, the performance characteristics identified for the memory devices at bloc 302 may be collected, extracted, and/or otherwise identified during the initialization of the host device 202, and stored in an ACPI System Resource Affinity Table (SRAT) included in the ACPI tables 402, an ACPI System Locality distance Information Table (SLIT) included in the ACPI tables 402, an ACPI Heterogeneous Memory Attribute Table (HMAT) included in the ACPI tables 402, and/or in any other ACPI table that would be apparent to one of skill in the art in possession of the present disclosure. To provide another specific example, the performance characteristics identified for the memory devices at block 302 may be collected by the BIOS during Power-On Self-Test (POST) operations during the initialization of the host device 202. However, while specific examples of the identification of performance characteristics for accessible memory devices has been described, one of skill in the art in possession of the present disclosure will appreciate how other techniques for identifying performance characteristics for accessible memory devices will fall within the scope of the present disclosure as well.

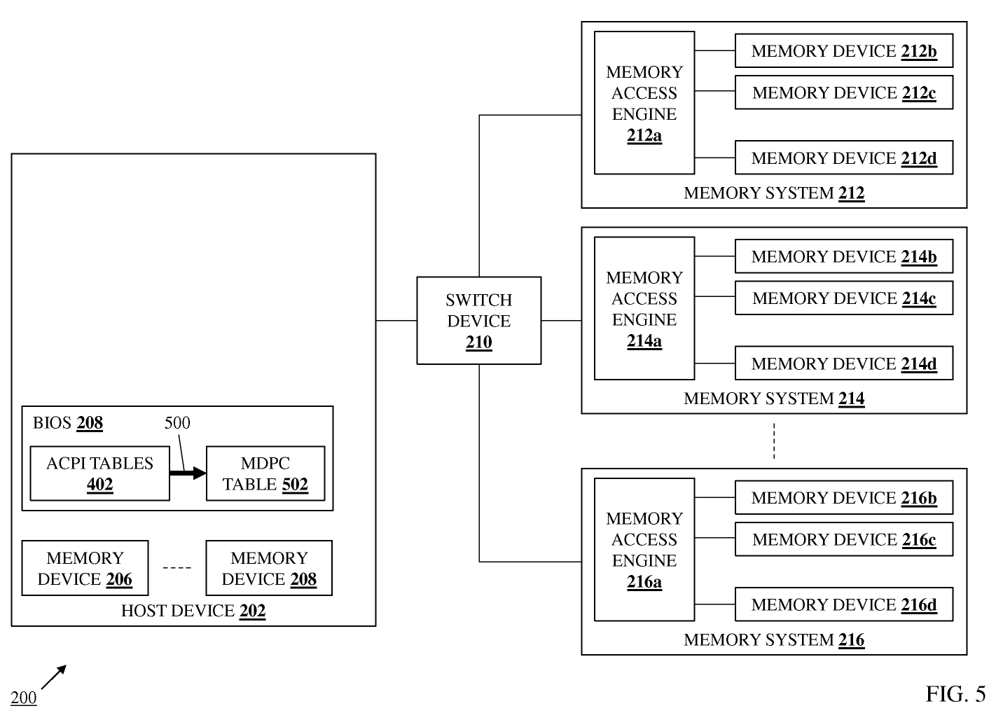

The method 300 then proceeds to block 304 where the BIOS creates an MDPC table including the performance characteristics identified for each of the memory devices. With reference to FIG. 5, in an embodiment of block 304 and during the initialization operations for the host device 202 described above, the BIOS 208 in the host device 202 may perform MDPC table creation operations 500 that include using the performance characteristics for the memory devices that were stored in the ACPI tables 402, collected by the BIOS 208 during POST operations, and/or otherwise identified at block 302 to create an MDPC table 502 that identifies the performance characteristics of each of the memory devices 206-208 in the host device 202, each of the memory devices 212b-212d in the memory system 212, each of the memory devices 214b-214d in the memory system 214, and each of the memory devices 216b-216d in the memory system 216. As part or, or following, the creation of the MDPC table 502, the BIS 208 may expose the MDPC table 502 for use by a hypervisor engine and/or other operating system(s) as described in further detail below.

For example, the performance characteristics provided in the MDPC table for any memory device may include a memory device type of a network-accessible memory device (e.g., a “type 1” CXL memory device, a “type 2” CXL memory device, a “type 3” CXL memory device, etc.), a memory type of the memory (e.g., a High Bandwidth Memory (HBM) memory type, a Double Data Rate 4 (DDR4) memory type, a Double Data Rate 5 (DDR5) memory type, etc.) included on that memory device, a current mode of the memory in that memory device (e.g., an “HBM only” mode, an “HBM flat” mode, or an “HBM cache” mode for a memory device with an HMB memory type), a memory address range provided by that memory device, location information describing a location of that memory device, latency information for that memory device, Non-Uniform Memory Access (NUMA) information for that memory device, and/or any other memory device information that one of skill in the art in possession of the present disclosure is indicative of the performance characteristics of a memory device.

As will be appreciated by one of skill in the art in possession of the present disclosure, the MDPC table 502 of the present disclosure provides a new table that may conform to ACPI specifications and thus, while illustrated as being separate from the ACPI tables 402, may be included in those ACPI tables 402 while remaining within the scope of the present disclosure as well. To provide a specific example, a portion of an ACPI MDPC table provided according to the teachings of the present disclosure is provided below:

/ * Format: [HexOffset DecimalOffset ByteLength] FieldName : FieldValue

*/

[000h00004] Signature : “MDPC" [Memory Device Performance Characteristics Table]

[004h00044] Table Length : 000000F0

[008h00081] Revision : 01

[009h00091] Checksum : 73

[00Ah00106] Oem ID : “ACME"

[010h00168] Oem Table ID : “ACMEMDPC"

[018h00244] Oem Revision : 00000001

[01Ch00284] Asl Compiler ID : “PMCT"

[020h00324] Asl Compiler Revision : 00000001

[021h00361] Subtable Type : 01 [Memory Affinity]

[022h00371] Length : 28

[026h00414] Proximity Domain : 00000000

[027h00451] Memory Type : 00

[028h00461] Memory Mode : 00

[030h00478] Base Address : 0000000000100000

[038h00558] Address Length : 00000000BFF00000

[04Ch00634] Device Latency : 00000000

[052h00674] Flags (decoded below) : 00000001

Enabled : 1

Hot Pluggable : 0

Non-Volatile : 0

[05Bh00718] Device Location : 0000000000000000

[05Ch00791] Subtable Type : 01 [Memory Affinity]

[05Dh00801] Length : 28

[062h00814] Proximity Domain : 00000000

[063h00851] Memory Type : 00

[064h00861] Memory Mode : 00

[06Dh00948] Base Address : 0000000000100000

[076h01028] Address Length : 00000000BFF00000

[07Bh01064] Device Latency : 00000000

[082h01104] Flags (decoded below) : 00000001

Enabled : 1

Hot Pluggable : 0

Non-Volatile : 0

[086h01148] Device Location : 0000000000000000

In this example, lines 1-11 of the portion of the ACPI MDPC table provided above identify the MDPC table as an ACPI table, lines 12-24 of the portion of the ACPI MDPC table provided above identify performance characteristics for a first memory address range provided by a first memory device, and lines 25-38 of the portion of the ACPI MDPC table provided above identify performance characteristics for a second memory address range provided by a second memory device, and one of skill in the art in possession of the present disclosure will appreciate how the performance characteristics of memory address ranges provided by any number of memory devices may be identified in the ACPI MDPC table similarly as detailed above.

However, while a specific example of the identification of particular performance characteristics for memory devices in an MDPC table conforming to the ACPI specification has been illustrated and described, one of skill in the art in possession of the present disclosure will appreciate how the identification of any performance characteristics for any types of memory devices via an MDPC table provided using other table provisioning techniques will fall within the scope of the present disclosure as well.

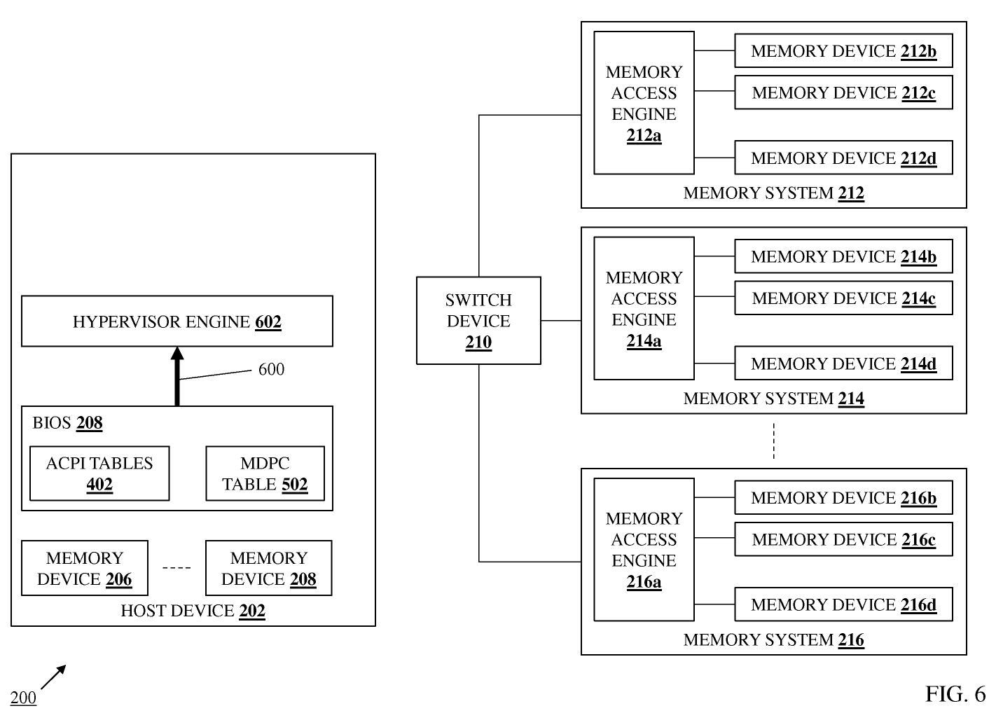

The method 300 then proceeds to block 306 where a hypervisor subsystem in the computing device provides virtual machines that each include a respective operating system that is allocated a respective memory pool provided by a respective subset of the memory devices. With reference to FIG. 6, and as will be appreciated by one of skill in the art in possession of the present disclosure, the initialization process for the host device 202 may result in the BIOS 208 performing hypervisor engine provisioning operations 600 that include providing a hypervisor engine 602 on the host device 202. For example, the initialization operations performed by the BIOS 208 may include the BIOS 208 configuring a primary memory system in the host device 202 (not illustrated, but which may include the memory 114 discussed above with reference to FIG. 1, and which may be provided by any of the memory devices 206-208 in the host device 202, and/or other memory devices that would be apparent to one of skill in the art in possession of the present disclosure) with instructions that, when executed by a primary processing system in the host device 202 (not illustrated, but which may include the processor 102 discussed above with reference to FIG. 1 such as, for example, a Central Processing Unit (CPU)), cause the primary processing system to provide the hypervisor engine 602 that is configured to perform the functionality of the hypervisor engines, hypervisor subsystems, and/or host devices discussed below.

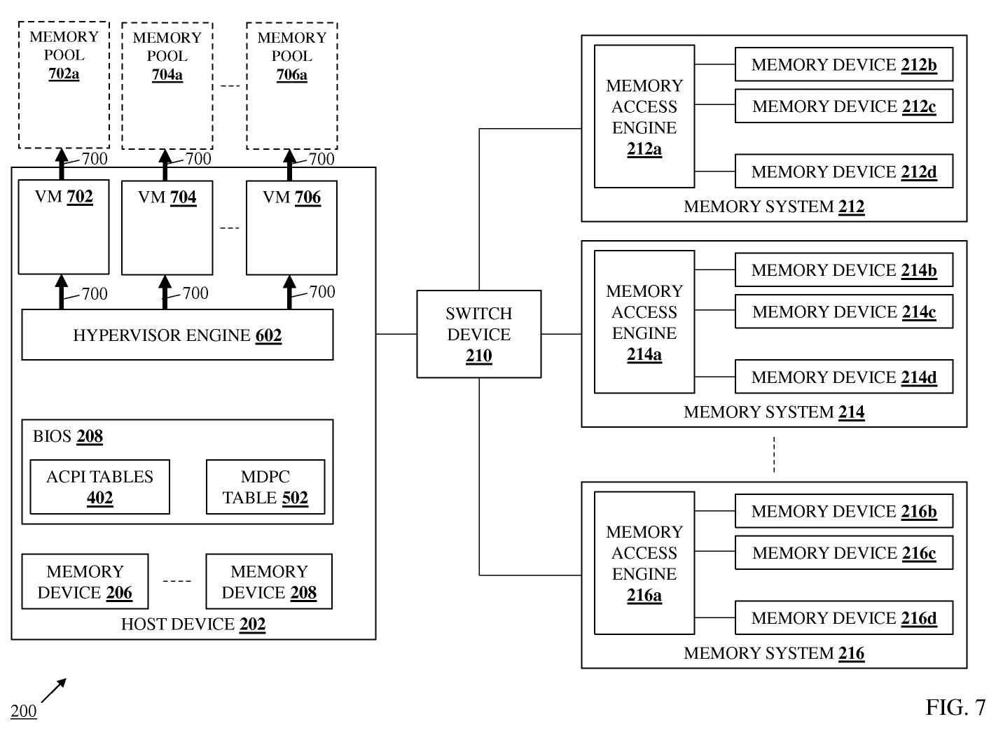

With reference to FIG. 7, in an embodiment of block 306, the hypervisor engine 602 may perform virtual machine provisioning operations 700 that include providing a plurality of virtual machines 702, 704, and up to 706 using host device hardware and/or other components included in and/or coupled to the host device 202, and one of skill in the art in possession of the present disclosure will appreciate how each virtual machine 702-706 may include a respective operating system as described in detail below. As illustrated in FIG. 7, the virtual machine provisioning operations 700 may include providing a memory pool 702a for the operating system included in the virtual machine 702, providing a memory pool 704a for the operating system included in the virtual machine 704, and providing a memory pool 706a for the operating system included in the virtual machine 706, and as described below, each of the memory pools 702a, 704, and up to 706a may include respective memory address range that is provided using a subset of the memory devices 206-208 in the host device 202, the memory devices 212b-212d in the memory system 212, the memory devices 214b-214d in the memory system 214, and the memory devices 216b-216d in the memory system 216.

In a specific example, at block 306, the hypervisor engine 602 may receive instruction(s) to create the virtual machines 702-706, and those instruction(s) may identify (or may cause the hypervisor engine 602 to identify) the respective subset of the memory devices 206-208 in the host device 202, the memory devices 212b-212d in the memory system 212, the memory devices 214b-214d in the memory system 214, and the memory devices 216b-216d in the memory system 216, that will provide the respective memory address ranges of each of the memory pools 702a-706a that are provided for use by the operating systems in each of the virtual machines 702-706, respectively. As such, the virtual machine provisioning operations 700 may include providing the virtual machines 702-706 and their respective memory pools 702a-706a that are provided by respective subsets of the memory devices 206-208 in the host device 202, the memory devices 212b-212d in the memory system 212, the memory devices 214b-214d in the memory system 214, and the memory devices 216b-216d in the memory system 216.

In the specific example provided below, the memory pool 706a is initially provided by the memory device 206 in the host device 202, the memory device 212d in the memory system 212, the memory device 214b in the memory system 214, and the memory device 216c in the memory system 216, and one of skill in the art in possession of the present disclosure will appreciate how the memory pools 702a-704a may be provided by similar subsets of the memory devices 206-208 in the host device 202, the memory devices 212b-212din the memory system 212, the memory devices 214b-214d in the memory system 214, and the memory devices 216b-216d in the memory system 216 while remaining within the scope of the present disclosure as well. However, while a specific example has been described, one of skill in the art in possession of the present disclosure will appreciate how the hypervisor engine 602 may provide virtual machines with respective memory pools that use subsets of accessible memory devices using other techniques that will fall within the scope of the present disclosure as well.

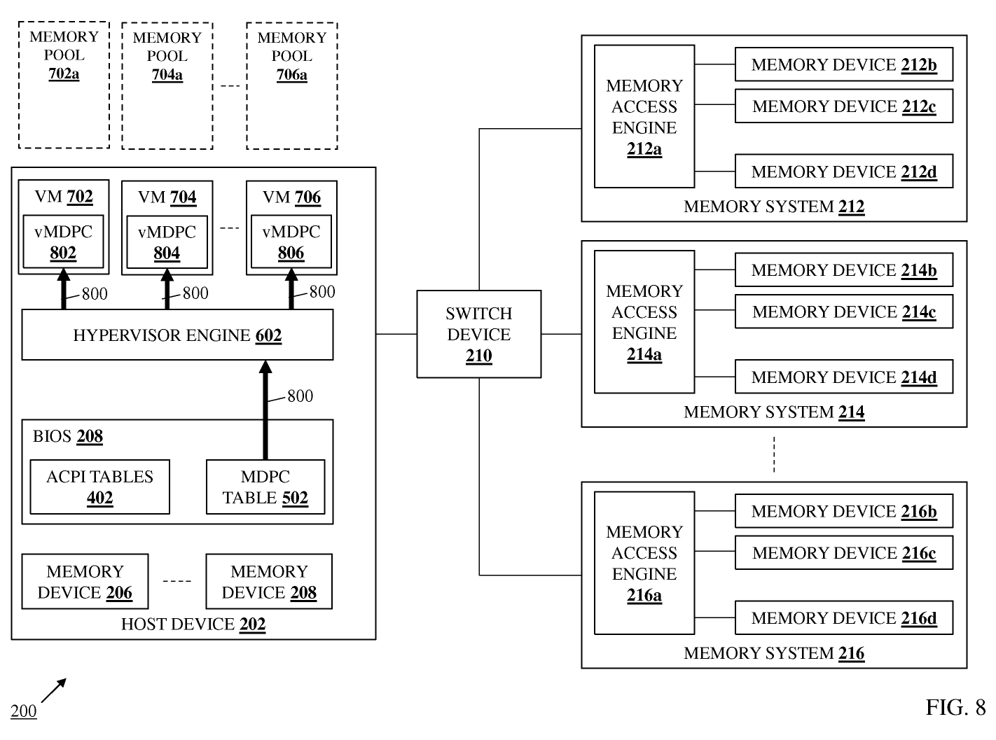

The method 300 then proceeds to block 308 where the hypervisor subsystem uses the MDPC table to create a respective vMDPC table for each operating system that identifies performance characteristics for each of the respective subset of memory devices allocated to that operating system. With reference to FIG. 8, in an embodiment of block 308, the hypervisor engine 602 may then perform vMDPC table creation operations 800 that include creating a respective vMDPC table 802, 804, and up to 806 for the operating system provided by each of the virtual machine 702, 704, and up to 706, respectively, that identifies the performance characteristics of the subset of the memory devices 206-208 in the host device 202, the memory devices 212b-212d in the memory system 212, the memory devices 214b-214d in the memory system 214, and the memory devices 216b-216d in the memory system 216 that are allocated to that operating system for use in performing operating system memory operations for its virtual machine.

In the specific example provided below, the vMDPC table 806 created at block 308 for the operating system provided by the virtual machine 706 initially identifies performance characteristics for each of the memory device 206 in the host device 202, the memory device 212d in the memory system 212, the memory device 214b in the memory system 214, and the memory device 216c in the memory system 216 that are being used to provide the memory pool 706a for that operating system, and one of skill in the art in possession of the present disclosure will appreciate how the hypervisor engine 602 may create the vMDPC tables 702-704 that identify performance characteristics for the respective subsets of memory devices that are being used to provide the memory pools 702a-704a, respectively, for the operating systems provided by the virtual machines 702-704, respectively, in a similar manner.

In an embodiment, at block 308 and as part of the creation of the vMDPC tables 802-806, the hypervisor engine 602 may isolate each of the vMDPC tables 802-806 for use by their respective operating system provided by the virtual machines 702-706, respectively, which one of skill in the art in possession of the present disclosure will appreciate may include utilizing any memory system/table isolation techniques known in the art in order to allow the operating system provided by the virtual machine 702 to access the vMDPC table 802 while preventing the operating systems provided by the virtual machines 704-706 from accessing the vMDPC table 802, to allow the operating system provided by the virtual machine 704 to access the vMDPC table 804 while preventing the operating systems provided by the virtual machines 702 and 706 from accessing the vMDPC table 804, and to allow the operating system provided by the virtual machine 706 to access the vMDPC table 806 while preventing the operating systems provided by the virtual machines 702-704 from accessing the vMDPC table 806. As such, as part of the creation of each virtual machine 702-706, each vMDPC table 802-806 may be created as part of a secure virtual environment for that virtual machine 702-706, respectively.

The method 300 then proceeds to block 310 where the operating systems perform operating system memory operations using any of the respective subset of the memory devices that are allocated to that operating system and that are selected based on performance characteristics identified in their vMDPC tables. With reference to FIG. 8, in an embodiment at block 310 and continuing with the specific example of the virtual machine 706, the memory pool 706a, and the vMDPC table 806 discussed above, at block 310 the operating system provided by the virtual machine 806 may perform operating system memory operations 900 using any of the memory devices 206, 212d, 214b, and/or 216c that provide the memory pool 706a based on the vMDPC table 806, and one of skill in the art in possession of the present disclosure will appreciate how the operating systems provided by the virtual machines 802-804 may perform similar operating system memory operations using any of the memory devices in their memory pools 702a-704a, respectively, based on their vMDPC tables 802-804, respectively.

For example, the operating system in the virtual machine 706 (e.g., a guest operating system scheduler provided by that operating system) may use the performance characteristics identified in the vMDPC table 806 to allocate one of the memory devices 206, 212d, 214b, and/or 216c that provide the memory pool 706a for use in performing any particular operating system memory operation for a workload running on that virtual machine 706, and one of skill in the art in possession of the present disclosure will recognize how the performance characteristics identified in the vMDPC table (e.g., the memory device type, memory type, mode of operation, latency, memory affinity to the processing subsystem in the host device 202 that is providing the operating system, etc.) may allow the operating system to identify one of the memory devices 206, 212d, 214b, and/or 216c that provides for the performance of that operating system memory operations] at a higher performance level (e.g., faster, more efficiently, etc.) than the others of the memory devices 206, 212d, 214b, and/or 216c. Furthermore, while the allocation of one memory device for use in performing a particular operating system memory operation is described herein, one of skill in the art in possession of the present disclosure will appreciate how the allocation of more than one memory device for use in performing a particular operating system memory operation will fall within the scope of the present disclosure as well.

To provide a specific example, the memory pool 706a may include an HBM memory device that may be selected for use in performing read and write operating system memory operations for a workload provided by the operating system on the virtual machine 806 because it provides better read and write performance (e.g., faster reads and writes, more efficient reads and writes, etc.) relative to DDR memory devices (DDR4 and DDR5 memory devices) that are included in the memory pool 706a. Similarly, a particular type of CXL memory device may be selected for use in performing any particular operating system memory operation for a workload provided by the operating system on the virtual machine 806 because it provides better performance relative to the other types of CXL memory devices that are included in the memory pool 706a. As such, one of skill in the art in possession of the present disclosure will appreciate how different memory operations for a workload provided by the operating system on the virtual machine 806 may be performed using different memory devices in the memory pool 706a such that operating system memory operations for that workload are optimized.

The method 300 then proceeds to decision block 312 where the method 300 proceeds depending on whether a modification to a subset of the memory devices allocated to an operating system is identified. As will be appreciated by one of skill in the art in possession of the present disclosure, any of the memory pools 702a-706a utilized by the operating systems in the virtual machines 702-706, respectively, may be modified by removing a memory device from the host device 202 or memory systems 212-216 (e.g., “hot-removing” that memory device), adding a memory device to the host device 202 or memory systems 212-216 (e.g., “hot-plugging” that memory device), a memory device failing or otherwise becoming unavailable, and/or in other memory pool modification scenarios that would be apparent to one of skill in the art in possession of the present disclosure.

As such, in an embodiment of decision block 312, the hypervisor engine 602 (e.g., a hypervisor memory scheduler provided by the hypervisor engine 602) may monitor the memory devices 206-208 in the host device 202, the memory devices 212b-212d in the memory system 212, the memory devices 214b-214din the memory system 214, and the memory devices 216b-216din the memory system 216 in order to detect whether any modifications occur in the memory pools 702a-706a. If, at decision block 312, no modification to a subset of the memory devices allocated to an operating system is identified, the method 300 returns to block 310. As such, the method 300 may loop such that the operating systems provided by the virtual machines 702-706 continue to perform operating system memory operations using their respective memory pools 702a-706a based on their respective vMDPC tables 802-806.

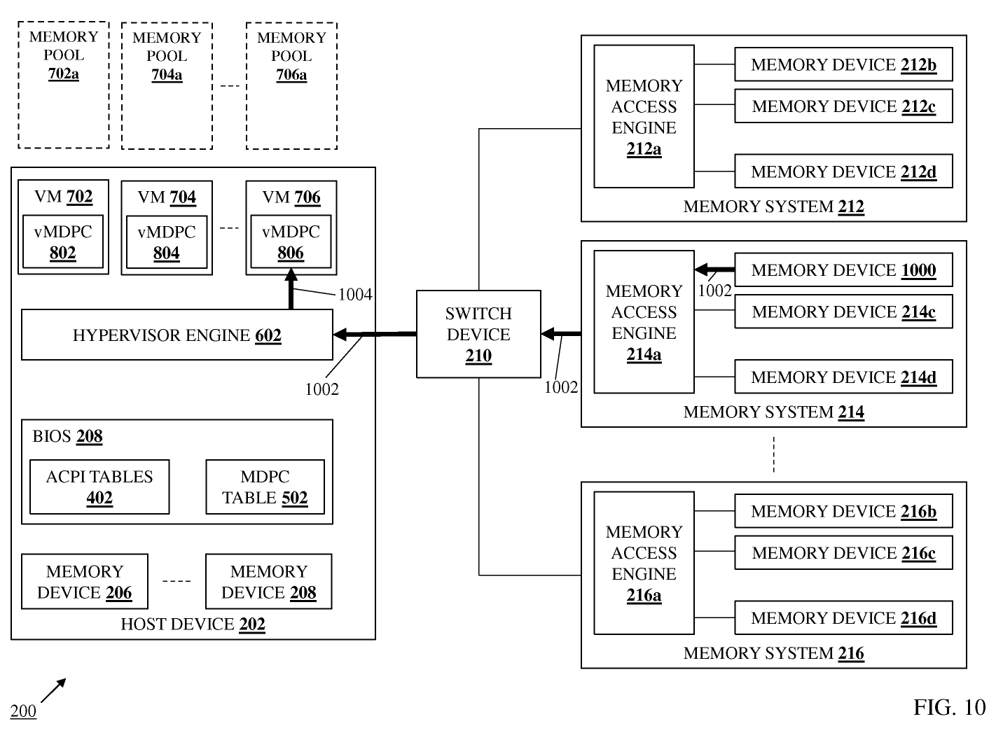

If, at decision block 312, a modification to a subset of the memory devices allocated to an operating system is identified, the method 300 proceeds to block 314 where the hypervisor subsystem modifies the vMDPC table for that operating system based on the modification identified for the subset of the memory devices allocated to that operating system. With reference to FIG. 10, in an embodiment of decision block 312, the memory device 214b may be removed from the memory system 214 and replaced with memory device 1000. In response, the hypervisor engine 602 may perform memory pool modification identification operations 1002 that may include identifying that the memory pool 706a has been modified due to the removal of the memory device 214b and its replacement by the memory device 1000. In some embodiments, the memory pool modification identification operations 1002 may include identifying performance characteristics of the memory device 1000 that may include any of the memory device performance characteristics described above, although one of skill in the art in possession of the present disclosure will appreciate how the identification that the memory pool 706a has been modified, followed by the identification of the performance characteristics for a new memory device that provided that modification, will fall within the scope of the present disclosure as well.

With continued reference to FIG. 10, in an embodiment of block 314, the hypervisor engine 602 may perform vMDPC table modification operations 1004 that may include adding the performance characteristics for the memory device 1000 to the vMDPC table 806, removing the memory device 214b and its performance characteristics from the vMDPC table 806, and/or any other vMDPC table modifications that would be apparent to one of skill in the art in possession of the present disclosure. To provide a specific example, in response to a modification to the memory pool 706a, the hypervisor engine 602 may “refresh” the memory address range provided by the memory device 206 in the host device 202, the memory device 212d in the memory system 212, the memory device 1000 in the memory system 214, and the memory device 216c in the memory system 216 that are now being used to provide the memory pool 706a, “refresh” the ACPI tables 402 with the memory device information for those memory devices similarly as described above, “refresh” the MDPC table 502 with the performance characteristics for those memory devices, and then “refresh” the vMDPC table 806 using the “refreshed” MDPC table 502.

Furthermore, while not illustrated or described in detail, one of skill in the art in possession of the present disclosure will appreciate how the hypervisor engine 602 may modify the vMDPC tables 802-804 in response to any modifications to the memory pools 702a-704a, respectively, in a similar manner while remaining within the scope of the present disclosure as well. Further still, one of skill in the art in possession of the present disclosure will appreciate how the hypervisor engine 602 may be instructed (e.g., by a user) to modify any of the memory pools 702a-706a by, for example, adding memory capacity to any of the memory pools 702a-706a, and in response may modify the vMDPC tables 802-806 similarly as described above. The method 300 may then return to block 310. As such, the method 300 may loop such that the operating systems provided by the virtual machines 702-706 continue to perform operating system memory operations using their respective memory pools 702a-706a based on their respective vMDPC tables 802-806, while modifying the vMDPC tables 802-806 when modifications occur to their respective memory pools 702a-706a.

Thus, systems and methods have been described that create a Memory Device Performance Characteristics (MDPC) table that includes performance characteristics for memory devices that are accessible to a computing device, and then use the MDPC table to create a virtual MDPC (vMDPC) table for an operating system running on a virtual machine provided by that computing device, with the vMDPC table identifying the performance characteristics for a subset of the memory devices in a memory pool that are allocated to that operating system, and with the vMDPC table used by that operating system to select a particular one of that subset of memory devices to perform an operating system memory operation based on their relative performance characteristics. For example, the memory pool characteristic provisioning system of the present disclosure may include a computing device. A BIOS in the computing device identifies performance characteristics for memory devices coupled to the BIOS, and creates a Memory Device Performance Characteristics (MDPC) table including those performance characteristics. A hypervisor subsystem in the computing device provides a virtual machine with an operating system that is allocated a memory pool provided by a first subset of the memory devices, and uses the MDPC table to create a virtual MDPC (vMDPC) table for the operating system that identifies the performance characteristics for each of the first subset of the memory devices. The operating system then performs an operating system memory operation using one of the first subset of the memory devices that is selected based on its performance characteristics relative to the performance characteristics of the others of the first subset of the memory devices as identified in the vMDPC table. As such, virtual machine operating systems may optimize their operating system memory operations by utilizing memory devices with the best performance characteristics for those operating system memory operations.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A memory pool characteristic provisioning system, comprising:
a computing device;
a Basic Input/Output System (BIOS) that is included in the computing device and that is configured to:
identify a plurality of performance characteristics for each of a plurality of memory devices that are coupled to the BIOS; and
create a Memory Device Performance Characteristics (MDPC) table that includes the plurality of performance characteristics identified for each of the plurality of memory devices; and
a hypervisor subsystem that is included in the computing device, that is coupled to the BIOS, and that is configured to:
provide a first virtual machine including a first operating system that is allocated a first memory pool that is provided by a first subset of the plurality of memory devices; and
create, using the MDPC table, a first virtual MDPC (vMDPC) table for the first operating system that identifies the plurality of performance characteristics for each of the first subset of the plurality of memory devices, wherein the first operating system is configured to:
perform a first operating system memory operation using a first memory device included in the first subset of the plurality of memory devices that is selected based on first performance characteristics identified in the first vMDPC table for the first memory device relative to second performance characteristics identified in the first vMDPC table for at least one second memory device included in the first subset of the plurality of memory devices.

2. The system of claim 1, wherein the BIOS is configured to:
identify the plurality of performance characteristics for each of the plurality of memory devices in a plurality of Advanced Configuration and Power Interface (ACPI) tables, and wherein the MDPC table is included in the ACPI tables.

3. The system of claim 1, wherein the hypervisor subsystem is configured to:
provide a second virtual machine including a second operating system that is allocated a second memory pool that is provided by a second subset of the plurality of memory devices; and
create, using the MDPC table, a second vMDPC table for the second operating system that identifies the plurality of performance characteristics for each of the second subset of the plurality of memory devices, wherein the second operating system is configured to:
perform a second operating system memory operation using a first memory device included in the second subset of the plurality of memory devices that is selected based on first performance characteristics identified in the second vMDPC table for the first memory device relative to second performance characteristics identified in the second vMDPC table for at least one second memory device included in the second subset of the plurality of memory devices.

4. The system of claim 3, wherein the hypervisor subsystem is configured to:
isolate the first vMDPC table for the first operating system such that the first vMDPC table is not accessible by the second operating system included on the second virtual machine; and
isolate the second vMDPC table for the second operating system such that the second vMDPC table is not accessible by the first operating system included on the first virtual machine.

5. The system of claim 1, wherein the hypervisor subsystem is configured to:
identify a modification to the first subset of the plurality of memory devices; and
modify the first vMDPC table for the first operating system based on the modification identified for the first subset of the plurality of memory devices.

6. The system of claim 1, wherein the first subset of the plurality of memory devices includes at least one memory device that is included in the computing device, and at least one memory device that is coupled to the computing device via a network.

7. The system of claim 6, wherein the first subset of the plurality of memory devices each include a performance characteristic provided by a memory device type such that the plurality of memory devices include at least one a High Bandwidth Memory (HBM) memory device type, at least one Double Data Rate (DDR) memory device type, and at least one Compute eXpress Logic (CXL) memory device type.

8. An Information Handling System (IHS), comprising:
a Basic Input/Output System (BIOS) processing system;
a BIOS memory system that is coupled to the BIOS processing system and that includes instructions that, when executed by the BIOS processing system, cause the BIOS processing system to provide a BIOS that is configured to:
identify a plurality of performance characteristics for each of a plurality of memory devices that are coupled to the BIOS processing system; and
create a Memory Device Performance Characteristics (MDPC) table that includes the plurality of performance characteristics identified for each of the plurality of memory devices;
a hypervisor processing system; and
a hypervisor memory system that is coupled to the hypervisor processing system and that includes instructions that, when executed by the hypervisor processing system, cause the hypervisor processing system to provide a hypervisor engine that is configured to:
provide a first virtual machine including a first operating system that is allocated a first memory pool that is provided by a first subset of the plurality of memory devices; and
create, using the MDPC table, a first virtual MDPC (vMDPC) table for the first operating system that identifies the plurality of performance characteristics for each of the first subset of the plurality of memory devices, wherein the first operating system is configured to:
perform a first operating system memory operation using a first memory device included in the first subset of the plurality of memory devices that is selected based on first performance characteristics identified in the first vMDPC table for the first memory device relative to second performance characteristics identified in the first vMDPC table for at least one second memory device included in the first subset of the plurality of memory devices.

9. The IHS of claim 8, wherein the BIOS is configured to:
identify the plurality of performance characteristics for each of the plurality of memory devices in a plurality of Advanced Configuration and Power Interface (ACPI) tables, and wherein the MDPC table is included in the ACPI tables.

10. The IHS of claim 8, wherein the hypervisor engine is configured to:
provide a second virtual machine including a second operating system that is allocated a second memory pool that is provided by a second subset of the plurality of memory devices; and
create, using the MDPC table, a second vMDPC table for the second operating system that identifies the plurality of performance characteristics for each of the second subset of the plurality of memory devices, wherein the second operating system is configured to:
perform a second operating system memory operation using a first memory device included in the second subset of the plurality of memory devices that is selected based on first performance characteristics identified in the second vMDPC table for the first memory device relative to second performance characteristics identified in the second vMDPC table for at least one second memory device included in the second subset of the plurality of memory devices.

11. The IHS of claim 10, wherein the hypervisor engine is configured to:
isolate the first vMDPC table for the first operating system such that the first vMDPC table is not accessible by the second operating system included on the second virtual machine; and
isolate the second vMDPC table for the second operating system such that the second vMDPC table is not accessible by the first operating system included on the first virtual machine.

12. The IHS of claim 8, wherein the hypervisor engine is configured to:
identify a modification to the first subset of the plurality of memory devices; and
modify the first vMDPC table for the first operating system based on the modification identified for the first subset of the plurality of memory devices.

13. The IHS of claim 8, wherein the first subset of the plurality of memory devices each include a performance characteristic provided by a memory device type such that the plurality of memory devices include at least one a High Bandwidth Memory (HBM) memory device type, at least one Double Data Rate (DDR) memory device type, and at least one Compute eXpress Logic (CXL) memory device type.

14. A method for providing memory pool performance characteristics, comprising:
identifying, by a Basic Input/Output System (BIOS) that is included in a computing device, a plurality of performance characteristics for each of a plurality of memory devices; and
creating, by the BIOS, a Memory Device Performance Characteristics (MDPC) table that includes the plurality of performance characteristics identified for each of the plurality of memory devices;
providing, by a hypervisor subsystem that is included in the computing device and that is coupled to the BIOS, a first virtual machine including a first operating system that is allocated a first memory pool that is provided by a first subset of the plurality of memory devices;
creating, by the hypervisor subsystem using the MDPC table, a first virtual MDPC (vMDPC) table for the first operating system that identifies the plurality of performance characteristics for each of the first subset of the plurality of memory devices; and
performing, by the first operating system provided by the hypervisor subsystem, a first operating system memory operation using a first memory device included in the first subset of the plurality of memory devices that is selected based on first performance characteristics identified in the first vMDPC table for the first memory device relative to second performance characteristics identified in the first vMDPC table for at least one second memory device included in the first subset of the plurality of memory devices.

15. The method of claim 14, further comprising:
identifying, by the hypervisor subsystem, the plurality of performance characteristics for each of the plurality of memory devices in a plurality of Advanced Configuration and Power Interface (ACPI) tables, and wherein the MDPC table is included in the ACPI tables.

16. The method of claim 14, further comprising:
providing, by the hypervisor subsystem, a second virtual machine including a second operating system that is allocated a second memory pool that is provided by a second subset of the plurality of memory devices;
creating, by the hypervisor subsystem using the MDPC table, a second vMDPC table for the second operating system that identifies the plurality of performance characteristics for each of the second subset of the plurality of memory devices; and
performing, by the second operating system provided by the hypervisor subsystem, a second operating system memory operation using a first memory device included in the second subset of the plurality of memory devices that is selected based on first performance characteristics identified in the second vMDPC table for the first memory device relative to second performance characteristics identified in the second vMDPC table for at least one second memory device included in the second subset of the plurality of memory devices.

17. The method of claim 16, further comprising:
isolating, by the hypervisor subsystem, the first vMDPC table for the first operating system such that the first vMDPC table is not accessible by the second operating system included on the second virtual machine; and
isolating, by the hypervisor subsystem, the second vMDPC table for the second operating system such that the second vMDPC table is not accessible by the first operating system included on the first virtual machine.

18. The method of claim 14, further comprising:
identifying, by the hypervisor subsystem, a modification to the first subset of the plurality of memory devices; and
modifying, by the hypervisor subsystem, the first vMDPC table for the first operating system based on the modification identified for the first subset of the plurality of memory devices.

19. The method of claim 14, further comprising:
wherein the first subset of the plurality of memory devices includes at least one memory device that is included in the computing device, and at least one memory device that is coupled to the computing device via a network.

20. The method of claim 14, wherein the first subset of the plurality of memory devices each include a performance characteristic provided by a memory device type such that the plurality of memory devices include at least one a High Bandwidth Memory (HBM) memory device type, at least one Double Data Rate (DDR) memory device type, and at least one Compute eXpress Logic (CXL) memory device type.
